(19) United States
(12) Patent Application Publication
(10) Pub. No.: US 2009/0046274 A1
(43) Pub. Date: Feb. 19, 2009

(54) Light Scattering Methods and Systems Using Supercritical Fluid Solvents to Measure Polymer Molecular Weight and Molecular Weight Distribution

(76) Inventors: Mark A. McHugh, Richmond, VA (US); Andrei F. Kostko, Richmond, VA (US); Koji Kigawa, Rye, NY (US); Katsuyoshi Kubo, Osaka (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/177,572

(22) Filed: Jul. 22, 2008

Related U.S. Application Data
(60) Provisional application No. 60/956,152, filed on Aug. 16, 2007.

(51) Int. Cl. G01N 21/00

(52) U.S. Cl. 356/72

(57) ABSTRACT

Light scattering processes are employed to measure molecular weight and related characteristics of polymeric materials, including without limitation refractory fluoropolymers. The processes utilize a pressurized cell and a fluid under pressure to solubilize the polymeric materials and to enable light scattering measurements to be performed.

### CROSS-REFERENCE TO RELATED APPLICATIONS

This application claims priority to U.S. Provisional Patent Application Ser. No. 60/956,152, filed on Aug. 16, 2007, and the complete contents thereof is herein incorporated by reference.

### FIELD OF THE INVENTION

The invention is generally related to light scattering methods and systems for measuring polymer molecular weight, molecular weight distribution, and other attributes of polymers.

### BACKGROUND

Static light scattering (SLS) is a well-known technique to obtain a reliable measurement of the polymer mass-average molecular weight, M_{w}, and the radius of gyration, R_{g}. With this technique the integrated intensity of scattered light is measured over a range of scattering angles for solutions with different polymer concentrations. The scattering intensities of the pure solvent that is used, as well as the scattering intensity of liquid solvent standard, such as benzene or toluene, are also measured with the same instrument. The solution, pure solvent, and liquid standard scattering intensities are interpreted with a special plot, such as a Zimm plot, that is a method used to extrapolate the scattering data to zero angle to minimize interference effects and to zero concentration to minimize polymer chain-chain interactions. The polymer M_{w} and R_{g} are obtained from the Zimm plot. Although SLS can be used to determine the M_{w} of a polymer sample of any molecular weight, the determination of R_{g} by this technique is limited to polymers with R_{g}>20 nm, which means that SLS does not work when R_{g} is too small in comparison with the wavelength of light.

Dynamic light scattering (DLS) is a convenient tool for measuring the hydrodynamic radius, R_{h,} of a polymer coil. Distribution of the hydrodynamic radius, as well as the average value is available via DLS. Molecular weight distribution could be obtained from the distribution of hydrodynamic radius if the relation of the molecular weight to the radius is established (see S. W. Provencher, J. Hendrix, L. De Maeyer, and N. Paulussen, Direct determination of molecular weight distributions of polystyrene in cyclohexane with photon correlation spectroscopy, J. Chem. Phys. 69, 4273 (1978)). It is noteworthy that DLS works well even in the range 20 nm>Rₕ where SLS fails with respect to R_{g} measurements. Fortunately, it is theoretically acceptable to use a reliable value of Rₕ to calculate R_{g} with a theoretically based coefficient, which for a Gaussian coil is 0.665 when using a theta solvent and 0.640 when using a good solvent.

### SUMMARY

This invention provides a method and system for the determination of polymer molecular weight and polymer molecular weight distribution for polymers, which are not soluble in conventional liquid solvents at ambient conditions, using combined static and dynamic light scattering techniques and high pressure to solubilize the polymer in a solvent.

According to the invention, SLS and DLS measurements are made on a polymer which is dissolved in a solvent at a high pressure. Elevated temperatures and pressures may be required to dissolve the polymer, thus a pressurized cell is described which permits making SLS and DLS measurements on these polymers. With the proper choice of operating conditions as dictated by the polymer plus solvent phase behavior, it is possible to perform SLS and DLS measurements in a single-phase region, where the polymer is totally dissolved in the solvent, and to obtain reliable scattering data that are used to determine M_{w}, the molecular weight distribution, and R_{g}. The high-pressure light-scattering technique is most useful when working with “difficult-to-dissolve” (so-called refractory) polymers such as perfluorinated polymers, seminfluorinated polymers, and highly crystalline hydrocarbon polymers. Exemplary solvents which may be employed in the inventive method and system include supercritical CO₂, supercritical hydrocarbons, supercritical fluorocarbons, supercritical noble gases, supercritical water, and supercritical sulfur hexafluoride.

### DESCRIPTION OF THE DRAWINGS

FIG. 1. Schematic diagram of the high-pressure scattering cell. A. Side-view; B. Top-view. 1. sapphire window sealed with an o-ring and back-up ring; 2. scattering ports at various angles; 3. magnetic stir bar; 4. piston sealed with an o-ring; 5. platinum RTD used for temperature control.

FIG. 2. Schematic of the high-pressure dynamic light scattering instrument used in the present invention.

FIG. 3. Hc/R obtained from high-pressure SLS measurements for polymer A (1,1-difluoroethene/tetrafluoroethene/1,1,2,3,3,3-hexafluoro-1-propene, 50/21/29 mol %) dissolved in supercritical CO₂ at 140° C. and 14,000 psia. Circles represent data at scattering angles of 90 and 135° after extrapolation to zero angle. A weight average molecular weight of 21·10⁴ is obtained from an extrapolation of Hc/R to zero concentration as noted in equation 2.

FIG. 4. Molecular weight distributions for polymer A obtained from SLS/DLS measurements in dilute solutions of polymer A in supercritical CO₂ at 140° C. and 14,000 psia. The curves represent nine typical measurements.

FIG. 5. Hc/R obtained from high-pressure SLS measurements for polymer B (1,1-difluoroethene/tetrafluoroethene/1,1,2,3,3,3-hexafluoro-1-propene, 50/21/29 mol %) dissolved in supercritical CO₂ at 140° C., and 14,000 psia. Circles represent data at scattering angles of 90 and 135° after extrapolation to zero angle. A weight average molecular weight of 60·10⁴ is obtained from an extrapolation Hc/R to zero concentration as noted in equation 2.

FIG. 6. Molecular weight distributions for polymer B obtained from SLS/DLS measurements of 0.102 wt % polymer B in supercritical CO₂ at 140° C., and 14,000 psia.

FIG. 7. Hc/R obtained from high-pressure SLS measurements for polymer C (a fluorinated terpolymer referred to herein as terpolymer C) dissolved in supercritical CO₂ at 140° C. and 14,000 psia. A weight average molecular weight of 17·10⁴ is obtained from an extrapolation Hc/R to zero concentration as noted in equation 2.

FIG. 8. Molecular weight distributions for polymer C obtained from multiple SLS/DLS measurements in supercritical CO₂ at 140° C. and 14,000 psia.

FIG. 9. Hc/R obtained from high-pressure SLS measurements for polymer C dissolved in supercritical R152a at 170° C. and 6,000 psia. A weight average molecular weight of 17·10⁴ is obtained from an extrapolation Hc/R to zero concentration as noted in equation 2.

FIG. 10. Seven measurements of the molecular weight distribution of polymer C obtained in light scattering measurements in dilute solutions in supercritical R152a at 170° C. and 6,000 psia.

### DETAILED DESCRIPTION

A number of dilute solutions with various polymer concentration have to be prepared to be able to apply light-scattering methods for the determination of polymer molecular weight and molecular weight distribution. We use a high-pressure optical cell and apply high pressure and, if necessary, heat to prepare single-phase dilute solutions of such polymers, which are not dissolved in conventional solvents at ambient conditions.

It is recognized that in certain instances refractory polymers can be dissolved in a liquid that contains oligomers of the parent polymer at near-ambient pressure and elevated temperatures. However, light-scattering measurements with such solutions become a challenge because the very small difference of refractive indices of the parent polymer and its oligomers. Consequently, the light-scattering intensity in such polymer solutions is extremely low, which makes light-scattering measurements problematic.

As soon as it is demonstrated that a refractory polymer can be dissolved in a solvent at high pressures, high-pressure DLS and SLS measurements become viable. To clarify the application of our method we discuss here some details of light-scattering methods. Both DLS and SLS measurements provide valuable information about polymer coils in dilute solution. DLS measurements can be used to determine the z-average hydrodynamic radius, Rₕ, of a polymer coil in solution as well as the distribution of coil radii using a regularization analysis of the data. If the distribution is mono-modal, the z-average hydrodynamic radius and an estimate of the relative width of the radii distribution can be obtained alternatively with the cumulant analysis of the data. And it is possible to calculate the relative width of the molecular weight distribution from the relative width of the radii distribution. In contrast, SLS measurements can be used to determine the polymer weight-average molecular weight, M_{w}, and the z-average radius of gyration, R_{g}, which is only valid when R_{g}>20 nm. Neither of these light scattering methods separately provides a way to calculate the polymer molecular weight distribution. However, combined DLS and SLS measurements provide enough information to establish the relation of molecular weight with the radius of polymer coils, and, consequently to build the molecular weight distribution using as described below.

For SLS measurements the scattered light intensity, determined as a function of scattering angle and polymer concentration, is reported as the Rayleigh factor that contains several variables including the scattered light intensity, the distance from the scattering volume to the detector, and the scattering volume. To normalize the scattering data from our scattering cell, the reported Rayleigh factor of toluene is used as an accepted standard that allows for the determination of the excess Rayleigh ratio, Rₑₓ, for a polymer solution.

$${R}_{ex} = {R}_{toluene} \cdot \frac{{I}_{solution} - {I}_{solvent}}{{I}_{toluene}} \cdot \frac{{V}_{toluene}}{{V}_{solution}} \qquad ( 1 )$$

where Rₜₒₗᵤₑₙₑ is the Rayleigh factor for toluene, the liquid standard used here. Iₛₒₗᵤₜᵢₒₙ, Iₛₒₗᵥₑₙₜ, and Iₜₒₗᵤₑₙₑ are the measured light scattering intensities for the polymer solution, solvent, and toluene, and Vₛₒₗᵤₜᵢₒₙ and Vₜₒₗᵤₑₙₑ are the scattering volumes for the polymer solution and toluene, respectively. The ratio of volumes Vₜₒₗᵤₑₙₑ/Vₛₒₗᵤₜᵢₒₙ depends on optics geometry and also on the ratio of the refractive indices of the solution and the standard liquid. Specific optics of conventional DLS instrument has a small collecting aperture and a focused, narrow laser beam. This implies that two volumes are close and their ratio is approximately equal to one. We follow the NIST procedure for static light scattering characterization of standard polymer samples and accept the toluene Rayleigh factor, Rₜₒₗᵤₑₙₑ=1.406·10⁻⁵ cm⁻¹, measured at λ=632.8 nm. For our measurements with a laser with a wavelength λ=532 nm, Rₜₒₗᵤₑₙₑ is now 2.815·10⁻⁵ cm⁻¹ since Rₜₒₗᵤₑₙₑ˜λ⁻⁴.

The polymer mass-average molecular weight, M_{w}, is calculated from a value of HC/Rₑₓ, Equation (2), obtained from an extrapolation to zero polymer concentration, c, and a value of the scattering wave number q, equal to (4πn/λ)sin(θ/2),

$$\frac{Hc}{{R}_{ex}} = \frac{1}{{M}_{w} P ( {qR}_{g} )} ( 1 + 2 {A}_{2} {M}_{w} c + … ) , \qquad ( 2 )$$

where P(qR_{g}), the form factor related to the size and shape of the polymer coil, is equal to (1−q²R_{g}²/3) (see page 169 in B. J. Beme and R. Pecora, Dynamic Light Scattering with Applications to Chemistry, Biology, and Physics. Dover, 2000, pp. 376), n is the refractive index of solution, λ is the wavelength, θ the scattering angle, A₂ is the second osmotic virial coefficient, and the constant, H, is

$$H = \frac{1}{{N}_{A}} {( \frac{2 π n}{{λ}^{2}} \frac{d n}{d c} )}^{2} , \qquad ( 3 )$$

where N_{A} is Avagadro's number and dn/dc is the specific refractive index increment for the polymer-solvent solution. The value of dn/dc could be measured directly with a differential refractometer or estimated as dn/dc=(n_{polym.}−n_{solv.})/ρ_{polym.}, where n_{polym.} and n_{solv.} are polymer and the solvent refractive indices, and ρ_{polym.} is polymer density.

The SLS method provides information on the molecular weight, M_{w}, and the DLS method provides information on the molecular weight distribution. A correlation function, g₂(t), of light scattering intensity at a given scattering angle θ, is generated from DLS measurements. This correlation function is related to the electric field correlation function, g₁(t) that can be represented for polydisperse polymer coils in solution as a superposition of exponentials with various decay times

$${g}_{1} ( t ) = {\int }_{0}^{∞} H ( τ ) exp ( - t / τ ) d τ , \qquad ( 4 )$$

where τ is the decay time and the function H(τ) is the distribution of decay times that characterizes the correlation function. A regularization procedure (see S. W. Provencher, A constrained regularization method for inverting data represented by linear algebraic or integral equations, Comput. Phys. Comm. 27, 213, 229 (1982)) is used to obtain a discrete form of the distribution H(τ) from equation (4). The important point here is that H(τ) can be transformed into the polymer molecular weight distribution if the relation between Rₕ and M_{w} is available (see S. W. Provencher, J. Hendrix, L. De Maeyer, and N. Paulussen, Direct determination of molecular weight distributions of polystyrene in cyclohexane with photon correlation spectroscopy, J. Chem. Phys. 69, 4273 (1978)).

The magnitude of the distribution, Hᵢ, at a given decay time, τᵢ, is fixed by the product of two factors, Hᵢ=Iᵢ·P(qR_{g}), where Iᵢ is the intensity of scattering from all polymer coils that exhibits a characteristic time, τᵢ. For a monodisperse polymer the intensity of scattering by dilute polymer solution is proportional to polymer concentration and molecular weight (see I. Teraoka, Polymer Solutions: an Introduction to Physical Properties. Wiley, 2002).

Iᵢ∝cᵢMᵢ. (5)

A value of R_{g} is needed to calculate the form factor, P(qR_{g}). A reliable value for R_{g} is difficult to obtain from SLS measurements at high pressures. However, a value of R_{g} is obtained knowing Rₕ, obtained from DLS measurements using the Stokes-Einstein equation

$${R}_{h} = \frac{{k}_{B} T}{6 πη D} = \frac{{k}_{B} {Tq}^{2}}{6 πη} τ , \qquad ( 6 )$$

where k_{B} is the Boltzmann constant, T is temperature, and η is solvent viscosity. For a theta quality solvent (see I. Teraoka, Polymer Solutions: an Introduction to Physical Properties. Wiley, 2002)

$${R}_{g} = \frac{8}{3 \sqrt{π}} {R}_{h} = \frac{1}{0.665} {R}_{h} . \qquad ( 7 )$$

Whereas, for a good quality solvent (see page 187 in I. Teraoka, Polymer Solutions: an Introduction to Physical Properties. Wiley, 2002, pp. 338.)

$${R}_{g} = \frac{1}{0.640} {R}_{h} . \qquad ( 8 )$$

Polymer molecular weight, M, scales with the coil radius in the following manner

$${R}_{h} = \frac{1}{b} {M}^{v} -> M = {bR}_{h}^{1 / v} , \qquad ( 9 )$$

where ν=½ for a theta quality solvent and ν≈0.6 for a good quality solvent.

Equation (9) provides the means to convert the coil radii distribution, obtained from DLS measurements, into the polymer molecular weight distribution. The next step is to determine a value for the unknown scale factor b. However, this factor can be fit to match the weight-average molecular weight, M_{w}, calculated from the DLS-generated molecular weight distribution with the value of M_{w} obtained directly from SLS measurements. To calculate M_{w} from the coil radii distribution, the amplitudes of the distribution must be rescaled since these coil radii amplitudes correspond to z-average not weight-average molecular weights. M_{w} is calculated as

$${M}_{w} = \frac{\sum {c}_{i} {M}_{i} Δ {M}_{i}}{\sum {c}_{i} Δ {M}_{i}} = \frac{\sum \frac{{H}_{i}}{P ( {qR}_{i} )} Δ M}{\sum \frac{{H}_{i}}{{M}_{i} P ( {qR}_{i} )} Δ {M}_{i}} . \qquad ( 10 )$$

The values of ΔMᵢ are the intervals between discrete points on the molecular-weight scale of the distribution.

The number-average molecular weight, Mₙ, is written as

$${M}_{n} = \frac{\sum {c}_{i} Δ {M}_{i}}{\sum \frac{{c}_{i}}{{M}_{i}} Δ {M}_{i}} = \frac{\sum \frac{{H}_{i}}{{M}_{i} P ( {qR}_{i} )} Δ {M}_{i}}{\sum \frac{{H}_{i}}{{M}_{i}^{2} P ( {qR}_{i} )} Δ {M}_{i}} . \qquad ( 11 )$$

Hence, M_{w}/Mₙ is calculated as

$$\begin{matrix}\frac{{M}_{w}}{{M}_{n}} = \frac{\sum {c}_{i} {M}_{i} Δ {M}_{i} \sum \frac{{c}_{i}}{{M}_{i}} Δ {M}_{i}}{{( \sum {c}_{i} Δ {M}_{i} )}^{2}} \\ = \frac{\sum \frac{{H}_{i}}{P ( {qR}_{i} )} Δ {M}_{i} \sum \frac{{H}_{i}}{{M}_{i}^{2} P ( {qR}_{i} )} Δ {M}_{i}}{{( \sum \frac{{H}_{i}}{{M}_{i} P ( {qR}_{i} )} Δ {M}_{i} )}^{2}} .\end{matrix} \qquad ( 12 )$$

An experimental apparatus and methods demonstrating the utility of the application are described below. It is recognized that the invention can be practiced with wide variation on the system components and materials as is well known by those skilled in the art of light scattering measurements and also skilled in the art of high pressure phase behavior and optical measurements discussed herein for exemplary purposes.

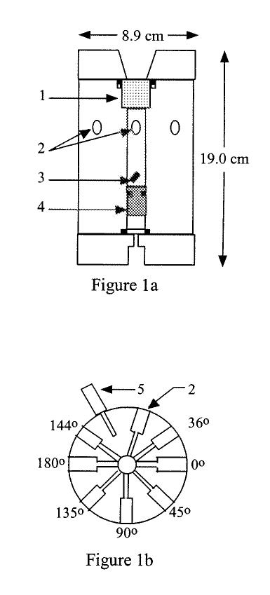

A laser beam is split and the intensity of one of the beams is measured to provide reference intensity. The incident laser beam is focused in the center of a high-pressure cell, which is shown in FIG. 1. FIG. 1a shows schematically a side view of the high-pressure cell, and FIG. 1b shows schematically the top view of the high pressure cell. In FIGS. 1a and 1b, there is shown a sapphire window sealed with an o-ring and back-up ring 1; scattering ports 2 at various angles; a magnetic stir bar 3; a piston 4 sealed with an o-ring; and a platinum RTD used for temperature control. One of the windows in the cell is for the incident laser beam and the other windows are for the detection of scattered light at angles of 135°, 90°, 45°, and 36°. A floating piston in the scattering cell separates the polymer solution from the fluid in the pressure line, which is the outlet line from a separate high-pressure cell equipped with its own floating piston. The line between the scattering cell and the pressurizing cell is filled with pure solvent to minimize any contamination of the polymer sample in the scattering cell. Water is used as the fluid to move the piston in the pressurizing cell; however, other fluids may substitute for water in certain applications. The pressure behind both pistons is measured with separate transducers, preferably accurate to within ±50 psi, and the pressure in the scattering cell preferably remains stable to within ±10 psi up to the pressure limit of the entire apparatus, which is approximately 36,000 psia (˜2500 bar). The temperature of the scattering cell is preferably controlled to within ±0.2° C. as measured with a thermocouple calibrated to within ±0.2° C. and located inside the cell.

The scattering cell is placed at the center of the goniometer with the light detector located on the turning arm that can be fixed to a specific angle. The detector has a spatial filter with a lens, diaphragm, and pinhole that provide coherent detection of the scattered light which is needed for dynamic light scattering measurements. The detector is equipped with two photomultiplier tubes (PMT) that provide the cross-correlation option to suppress the distortion of the correlation function resulting from after pulses of the PMT.

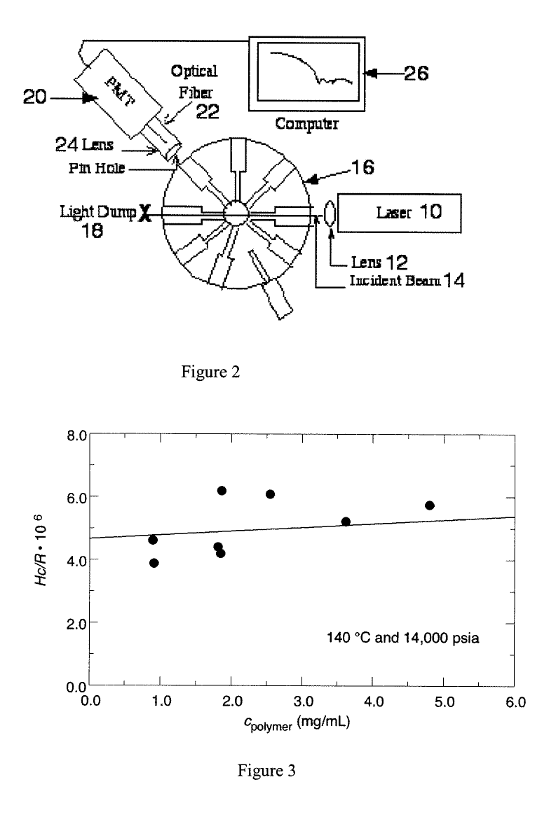

FIG. 2 shows a schematic of a high-pressure, light scattering apparatus which can be used for SLS/DLS measurements with solvents under pressure. A laser 10 fitted with lens 12 directs an incident beam of radiant energy 14 into the high pressure cell 16. Light energy which passes straight through the cell 16 is dumped at light dump 18. Scattered light is measured and recorded using a photomultiplier tube 20 fitted with an optical fiber 22 and lens 24. The scattered light that passes through a pin hole is detected and analyzed by the computer 26. There are a number of SLS and DLS instruments which are commercially available (see, for example, model BI-MwA, Molecular Weight Analyzer made by Brookhaven Instruments Corporation, or for example model DAWN HELEOS made by Wyatt Technology Corporation) but that operate at low pressures. It might be possible to perform suitable SLS/DLS measurements with these commercially-available systems if these systems could be modified to include a high pressure scattering cell similar to that shown in FIG. 1. The apparatus depicted in FIG. 2, used in the present invention, provides a means for measuring molecular weight characteristics of fluoropolymers and correlating fluoropolymer product performance with molecular weight information. Prior to this invention, there was almost no way to measure fluoropolymer characteristics since these types of materials do not dissolve in liquid solvents at room temperature. The measurements using solutions of fluoropolymers in liquid oligomers at near-ambient pressure are not viable because of the extremely low difference of refractive indices of polymer and of oligomers. The invention may have particular application in the determination of molecular weight characteristics of refractory fluoropolymers that are used in high technology markets such as medicine and microelectronics. However, it will be recognized by those of skill in the art that the apparatus could be used in measuring the molecular weight characteristics of other polymers, and particularly difficult to dissolve polymers.

### Proof of Concept

DLS/SLS experiments were performed in supercritical CO₂ at 140° C. and 14,000 psia with polymers A and B, whose properties are shown in Table 1. Values of Hc/R, extrapolated to zero wave number q, are shown in FIG. 3 as a function of polymer A concentration in CO₂ at 140° C. and 14,000 psia. In FIG. 3, circles represent data at scattering angles of 90 and 135° after extrapolation to zero angle. A weight average molecular weight of 21·10⁴ is obtained from an extrapolation of Hc/R to zero concentration as noted in equation 2. We find M_{w}, =21·10⁴ compared to a value of 17·10⁴ provided by the supplier of polymer A determined by light scattering using PMMA as a standard. The difference between these two values for M_{w} could be due to a difference in the physical properties of the samples used for the measurements and also to the experimental errors associated with both measurement techniques, but, these differences are not considered significant.
Table 1. Comparison of the weight average molecular weight and molecular weight polydisperity measured with conventional techniques to the same properties measured with the high-pressure DLS/SLS invention for two different polymers. These two polymers dissolve at low pressure so that conventional gel-permeation chromatography with conventional detectors can be used to determine M_{w} and M_{w}/Mₙ. The conventional technique also used PMMA as a standard for determining M_{w}.

| | | High-pressure | | High-pressure |
|---|---|---|---|---|
| | Conventional | SLS/DLS | Conventional | SLS/DLS |
| Poly- | Measurement | Measurement | Measurement | Measurement |
| mer | M_{w} (·10⁴) | M_{w} (·10⁴) | M_{w}/Mₙ | M_{w}/Mₙ |
| A | 17 | 21 | 1.42 | 2.1 ± 0.8 |
| B | 60 | 60 | 1.83 | 1.8 ± 0.5 |

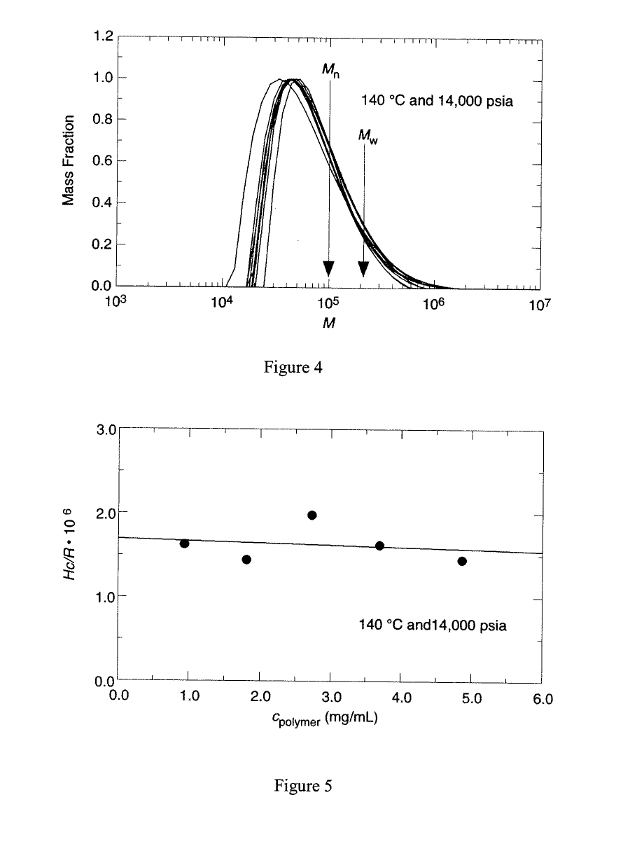

FIG. 4 shows the molecular weight distribution for polymer A obtained in the present invention. The averaged molecular weight polydispersity, <M_{w}/Mₙ>, from these distributions is 2.1 with a standard deviation of 0.8 which is in good agreement with value of 1.42 for <M_{w}/Mₙ> reported by the supplier of polymer A shown in Table 1.

As further proof of concept for this high-pressure technique, SLS/DLS data were also obtained for polymer B in supercritical CO₂ at 140° C. and 14,000 psia. FIG. 5 shows the results for Hc/R as a function of polymer concentration for polymer B in CO₂. With our high-pressure technique we determined a weight average molecular weight, M_{w}, of 60·10⁴ in excellent agreement with the value reported by the supplier of polymer B using PMMA as a standard.

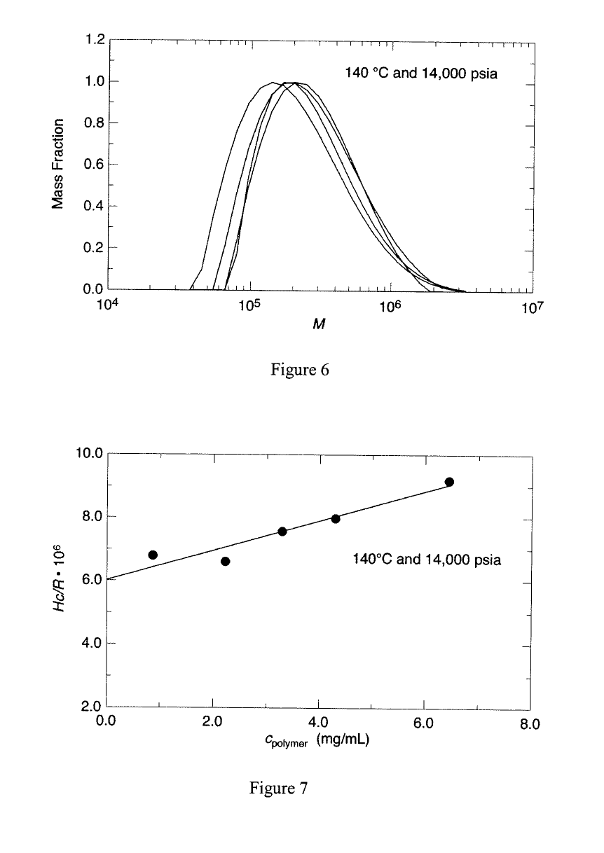

FIG. 6 shows the molecular weight distribution for polymer B obtained in the present invention from DLS data. The averaged molecular weight polydispersity, <M_{w}/Mₙ>, obtained from these distributions is 1.8 with a standard deviation of 0.5 in excellent agreement with the value of 1.83 for <M_{w}/Mₙ> reported by the supplier of polymer B shown in Table 1.

### EXAMPLE 1

### Terpolymer C in CO₂

Terpolymer C, which has 47 mol % tetrafluoroethylene, 10 mol % hexafluoropropylene, and 43 mol % ethylene and a density of 1.741 g/ml, was analyzed for the exemplary experiment demonstrating the functionality of the invention. Terpolymer C does not dissolve in a liquid solvent at ambient conditions. So it is difficult, or even impossible, to determine the molecular weight and molecular weight distribution of this fluorinated polymer. Therefore, this study has been performed with terpolymer C—CO₂ solutions at a single temperature of 140° C. and a single pressure of 14,000 psia (965 bar). Terpolymer C dissolves in CO₂ at ˜9,500 psia and 140° C., which means that the light scattering measurements are performed in a single-phase region for this mixture since the operating pressure is 14,000 psia. Terpolymer C—CO₂ solutions are prepared by loading a known amount of terpolymer C in a clean, high-pressure scattering cell, transferring a known amount of CO₂ into the cell, heating and pressurizing the solution to 14,000 psia (965 bar) and 140° C., mixing the solution with a magnetic stirring bar for several hours, and then allowing the solution to sit overnight without stirring so that polymer chains disentangle and obtain an equilibrium conformation and so that any dust particles in the solution settle to the bottom of the cell which is not in the line of sight of the laser beam. This method of solution preparation is a convenient way to remove dust from the solution since it is not easy to filter a single-phase, hot solution at high pressures. Scattering measurements are performed after the overnight treatment of the polymer solution and also after preheating the laser to achieve an acceptable stability of the laser intensity, which is critical for reliable static light scattering measurements. The accumulation of the scattered light intensity signal and the intensity correlation function is performed typically for 10 minutes for each run at a given angle. Several sets of scattering data are obtained at each angle of scattering. At the end of a series of scattering intensity measurements with a given terpolymer C—CO₂ solution, the high-pressure cell is cooled to ambient temperature while allowing the pressure to decrease simultaneously. The scattering cell is opened, dismantled, and thoroughly cleaned to prepare for the next scattering experiment.

For this example measurements of the intensity correlation function were performed for terpolymer C—CO₂ solutions at polymer concentrations (g/mL) of 8.45·10⁻⁰⁴, 1.97·10⁻⁰³, 2.71·10⁻⁰³, 3.65·10⁻⁰³, and 4.12·10⁻⁰³. The intensity correlation function measurements for each solution were performed at scattering angles of 135°, 90°, 45°, and 36° that are available with the experimental high-pressure apparatus. A regularization analysis was used to interpret the resultant correlation functions although one skilled in the art of DLS also knows that a cumulant analysis is possible under certain conditions.

The solution refractive index, needed to calculate q, is set equal to 1.1948, which is the refractive index for pure CO₂ at scattering conditions of 14,000 psia and 140° C. The density of CO₂ (ρ_{CO2}=0.91832 g/mL) at given pressure and temperature is used in the refractive index calculation and is obtained from an online NIST Standard Reference Database. The viscosity for supercritical CO₂ at 14,000 psia and temperature 140° C., η=9.7667·10⁻⁰⁵ Pa·s, was also obtained from the online NIST Standard Reference Database. A value of Rₕ=11.5 nm is obtained from the value of the diffusion coefficient determined from DLS measurements extrapolated to zero concentration and from equation 5, the Stokes-Einstein equation. A value of R_{g}=17 nm is calculated with equation 6 and is used to determine P(qR_{g}). This method of determination of R_{g} and P(qR_{g}) is rather convenient when the value of R_{g} appears to be too low for its accurate measurement via SLS.

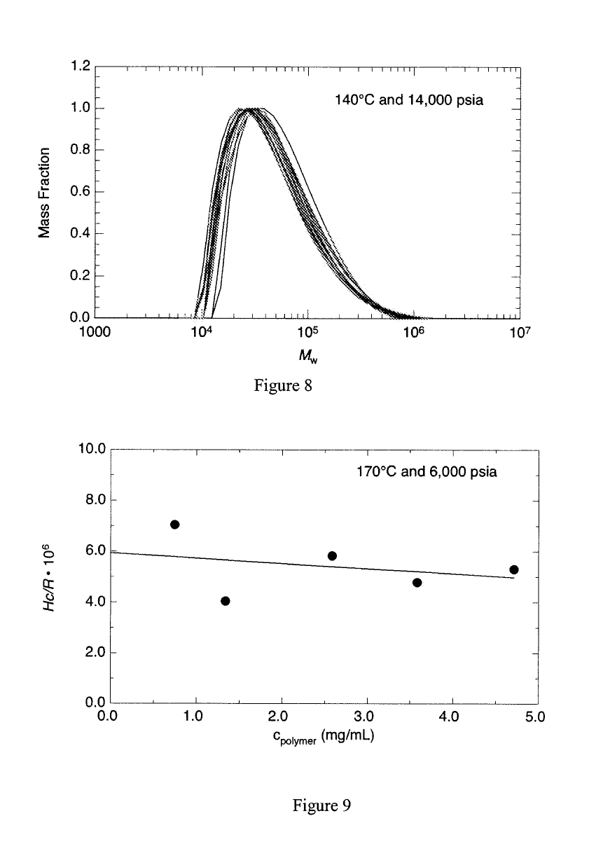

The value Hc/R, which is already extrapolated to zero wave number q, is extrapolated to zero concentration in FIG. 7 for terpolymer C to obtain a molecular weight, M_{w}, of 17·10⁴. FIG. 8 shows the molecular-weight distributions for terpolymer C obtained from light scattering measurements of dilute solutions in CO₂. An average M_{w}/Mₙ=2.5±0.6 is obtained from the analysis of twelve different distributions from the DLS experiments.

FIG. 8 shows molecular weight distributions for terpolymer C obtained from multiple SLS/DLS measurements in supercritical CO₂ at 140° C. and 14,000 psia.

It is important to recognize the advantage of using simultaneous dynamic and static light scattering methods to determine polymer characteristics. In this example the value of Rₕ=11.5 nm obtained from DLS measurements extrapolated to zero concentration is less than 532 nm, which is the laser wavelength. This low value of Rₕ implies that R_{g} is also a low value as compared with the laser wavelength and it is not possible to obtain an accurate measure of R_{g} using static light scattering. Therefore, we use the value of R_{g}=17 nm, obtained with DLS, for the treatment of the SLS data to obtain M_{w}. And, we then use the DLS data to obtain information on the molecular weight distribution for the polymer.

### EXAMPLE 2

### Terpolymer C in F152a

In this example the same terpolymer C is analyzed using SLS/DLS measurements, however, in this instance supercritical R152a (1,1-difluoro-ethane) is used as the solvent. Terpolymer C does not remain dissolved in R152a at temperatures below ˜150° C. Therefore, the SLS/DLS experiments are performed at 170° C. and 6,000 psia, which is well within the single phase region for this polymer-solvent mixture. Pure component data for R152a were found in the NIST WebBook, available online, and also in the paper by H. B. Chae et al., J. Phys. Chem., 94, 8840-8845 (1990).

The extrapolation of Hc/R to zero terpolymer C concentration shown in FIG. 9 results in an M_{w} equal to 17·10⁴. Hence, the M_{w} value for terpolymer C obtained with R152a is in excellent agreement with that obtained with CO₂. Although the R152a data exhibit a certain amount of scatter which leads to error in the M_{w} value, more measurements could be performed to reduce this error.

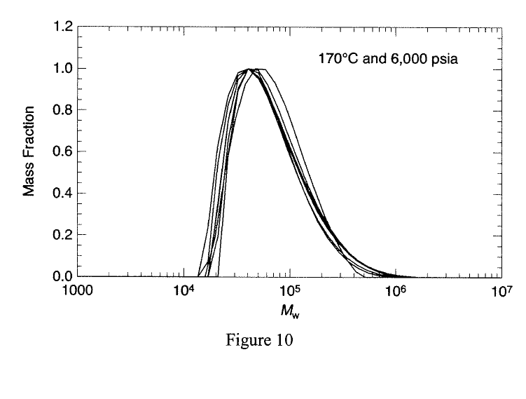

FIG. 10 shows the molecular weight distributions of terpolymer C obtained from light scattering measurements in dilute solutions in R152a. Here M_{w}/Mₙ=2.1±0.6 from the analysis of seven different distributions from the DLS experiments, which is in excellent agreement with the result obtained with supercritical CO₂.

While the invention has been described in the context of an exemplary embodiment, those of skill in the art will recognize that the invention can be practiced with variation in the scope and context of the appended claims.

1. A method of characterizing a polymer, comprising the steps of
solubilizing a polymer with at least a single fluid solvent under pressure and temperature conditions suitable to maintain said polymer in solution;
measuring light scattering characteristics of said solution; and
computing one or more of molecular weight, molecular weight distribution, radius of gyration, and hydrodynamic radius for said polymer from measurements made in said measuring step.

2. The method of claim 1 wherein said polymer is a perfluorinated polymer, copolymer, or terpolymer, a semi-fluorinated polymer, copolymer, or terpolymer, or a hydrocarbon polymer, copolymer, or terpolymer.

3. The method of claim 1 wherein said fluid solvent is supercritical fluid such as carbon dioxide, supercritical hydrocarbon such as ethane, propane, butane, pentane, supercritical freon such as F134a, F152a, F143b, F22, supercritical sulfur hexafluoride, supercritical tetrafluoromethane, supercritical hexafluoroethane, and supercritical hexafluoropropylene.

4. The method of claim 1 wherein said measurements are made at a single scattering angle.

4a. The method of claim 1 wherein said measurements are made at multiple scattering angles.

6. A method of characterizing a fluoropolymer, comprising the steps of
solubilizing said fluoropolymer with supercritical carbon dioxide under pressure and temperature conditions suitable to maintain said fluoropolymer in solution;
measuring light scattering characteristics of said solution; and
computing one or more of molecular weight, molecular weight distribution, radius of gyration, and hydrodynamic radius for said polymer from measurements made in said measuring step.

7. A system for characterizing a polymer in terms of one or more of molecular weight, molecular weight distribution, radius of gyration, and hydrodynamic radius for said polymer, comprising:
a cell for maintaining under pressure and temperature a solution comprised of said polymer and one or more supercritical fluids;
a laser light source projecting a laser beam on said cell;
a sensor for sensing scattered light from said cell; and
a computer for computing one or more of molecular weight, molecular weight distribution, radius of gyration, and hydrodynamic radius for said polymer from measurements made by said sensor.
